(19) United States
(12) Patent Application Publication
(10) Pub. No.: US 2010/0087187 A1
(43) Pub. Date: Apr. 8, 2010

(54) METHOD AND DEVICE OF REPORTING THE CAPABILITY OF A CELL TO SUPPORT UPLINK HIGH-ORDER MODULATION

(75) Inventors: Yazhu Ke, Shenzen (CN); Jian Zhang, Shenzen (CN)

Correspondence Address: Nixon Peabody LLP, P.O. Box 60610, Palo Alto, CA, 94306, US

(73) Assignee: ZTE Plaza, Keji Road South, Shenzhen, Guangdon Province (CN)

(21) Appl. No.: 12/532,124

(22) PCT Filed: Nov. 30, 2007
(86) PCT No.: PCT/CN2007/003403

§ 371 Date: Sep. 18, 2009

(30) Foreign Application Priority Data
Mar. 21, 2007 (CN) 200710087252.2

(51) Int. Cl. H04W 24/00

(52) U.S. Cl. 455/424

(57) ABSTRACT

A method and device for reporting the capability of a cell to support uplink high-order modulation, in which drift radio network controller is used for reporting whether the relative cell supports uplink high-order modulation, wherein the method includes the following steps: the DRNC, after receiving a request message from the serving radio network controller, reports via signaling to SRNC the information about the capability of the relative cell to support the uplink high-order modulation and to enable the SRNC to obtain the information to determine whether to use the uplink high-order modulation method on user equipment.

### CROSS REFERENCE TO RELATED APPLICATIONS or PRIORITY CLAIM

This application is a national phase of International Application No. PCT/CN2007/003403, entitled “METHOD AND EQUIPMENT FOR REPORTING SUPPORT CAPABILITY OF CELL TO UPLINK HIGH-ORDER MODULATION”, which was filed on Nov. 30, 2007 and which claims priority of Chinese Patent Application No. 200710087252.2, filed Mar. 21, 2007.

### FIELD OF THE INVENTION

The present invention relates to radio communication system, and in particular to a method and device of reporting the capability of a cell to support uplink high-order modulation, in which a drift radio network controller (DRNC) is used for reporting whether the relative cell controlled by it supports uplink high-order modulation.

### BACKGROUND OF THE INVENTION

An access network comprises one or more radio network subsystems, each of which is a sub-network of the access network and comprises a radio network controller and one or more nodes B. The access network controller is a network element responsible for controlling the radio resource of the access network. The main function of the Node B is to process the air interface physical layer and besides to perform some basic management operation on radio resource.

When a user equipment (UE) is setting up communication with a plurality of radio network controllers, if different radio network controls are connected via Iur port, the radio network controller responsible for linking the UE and the core network is referred to as serving radio network controller (SRNC), and the radio network controller responsible for transmitting the signaling and data of that UE but not linking it with the core network is referred to as drift radio network controller (DRNC). In addition, the DRNC is further responsible for transmitting to the SRNC the supporting capability of the cell of Node B under its' control.

In the technology optimization for existing system, in order to improve users' experience quality and system throughout, the high speed uplink packet access technology is continuously developed and so far 16 QAM high-order modulation mode has been introduced.

Thus, because the technology is newly introduced, only new Node B supports it, while old Node B does not support it. The terminal supporting this technology can utilize the function of the technology only when being cooperated by the Node B which supports this technology. During making the decision whether to use this technology, the access network side needs to take the backward compatibility into account and to determine whether Node B can use the technology, so as to make an exact decision.

Therefore, it is necessary to provide a method and device for reporting the capability of a cell to support uplink high-order modulation, in which a drift radio network controller is used to report whether the relative cell controlled by it supports uplink high-order modulation, in order to solve the above problem.

### SUMMARY OF THE INVENTION

Therefore, in order to solve the above problem, the present invention provides a method and device for reporting the capability of a cell to support uplink high-order modulation, in which DRNC is used to report whether the relative cell controlled by it supports uplink high-order modulation. In this method and device, DRNC is used to report SRNC whether the relative cell controlled by it supports uplink high-order modulation to, thus enabling the SRNC to obtain the information to determine whether to employ uplink high-order modulation on the UE.

In one aspect of the present invention, it provides a method for reporting the capability of a cell to support uplink high-order modulation, in which the DRNC is used for reporting whether the relative cell controlled by it supports uplink high-order modulation, comprising the following steps: after receiving a request message from the SRNC, the DRNC reports via signaling to the SRNC the information about the capability of the relative cell to support uplink high-order modulation.

Meanwhile, the request message may comprise any one of the following: radio link setup request message and radio link addition request message. The signaling may comprise any one of the following or the combination thereof: radio link setup response message, radio link setup failure message, radio link addition response message, and radio link addition failure message.

According to one aspect of the present invention, when the DRNC receives a radio link setup request message or a radio link addition request message and one or more desired links have been setup or added successfully, the information about the capability of the relative cell to support uplink high-order modulation is carried in the radio link setup response message or a radio link addition response message which is delivered to the SRNC.

Optionally, when the DRNC receives a radio link setup request message or a radio link addition request message and some of the plural links have been successfully setup or added but some of those have been failed to be setup or added, the information about the capability of the relative cell to support uplink high-order modulation is carried in the radio link setup failure message or a radio link addition failure message which is delivered to the SRNC.

According to one aspect of the present invention, the relative cell, including one or more cells, is the neighboring cell with successfully setup or added links after the DRNC receives the said request message. The reporting using signaling can be effected by adding the information about the capability of supporting uplink high-order modulation into the value of the cell capability container of the existing information cell.

In addition, according to one aspect of the present invention, the capability of supporting uplink high-order modulation can be represented in form of bit with “0” denoting not-supporting uplink high-order modulation and “1” denoting supporting uplink high-order modulation. In the information about the capability of supporting uplink high-order modulation, the capability of supporting uplink high-order modulation is indicated by adding the expanded cell capability information. The information about the supporting capability for uplink high-order modulation is represented by the supporting indication or the not-supporting indication.

According to one aspect of the present invention, the capability of supporting uplink high-order modulation may comprise any one of the following or the combination thereof: uplink 16 QAM supporting capability, 64 QAM supporting capability, OQAM supporting capability, the supporting capability for all modulation modes of 16 QAM and QAM with less levels, the supporting capability for all modulation modes of 64 QAM and QAM with less levels, and the supporting capability for all modulation modes of OQAM and QAM with less levels.

According to another aspect of the present invention, it provides a device for reporting the capability of a cell to support uplink high-order modulation, in which DRNC is used to report whether the relative cell controlled by it supports uplink high-order modulation and the device can comprise a reporting unit for reporting via signaling to SRNC the information about the capability of the relative cell to support uplink high-order modulation, after receiving the request message from SRNC.

Meanwhile, the request message can comprise any one of the following: radio link setup request message and radio link addition request message. The signaling can comprise any one of the following: radio link setup response message, radio link setup failure message, radio link addition response message, and radio link addition failure message.

According to another aspect of the present invention, when the DRNC receives a radio link setup request message or a radio link addition request message and one or more desired links have been setup or added successfully, the information about the capability of the relative cell to support uplink high-order modulation is carried in the radio link setup response message or the radio link addition response message delivered to the SRNC by the reporting unit.

According to another aspect of the present invention, when the DRNC receives a radio link setup request message or a radio link addition request message and some of the plural links have been successfully setup or added while some of those have been failed to be setup or added, the information about the capability of the relative cell to support uplink high-order modulation is carried in the radio link setup failure message or the radio link addition failure message delivered to the SRNC by the reporting unit.

According to another aspect of the present invention, the relative cell, including one or more cells, may be the neighboring cell with successfully setup or added links after the DRNC receives the request message.

In addition, the reporting using signaling can be effected by adding the information about the capability of supporting uplink high-order modulation into the cell capability container value of the existing information cell. The supporting capability for uplink high-order modulation can be represented in form of bit with “0” denoting not-supporting uplink high-order modulation and “1” denoting supporting uplink high-order modulation.

In the information about the supporting capability for uplink high-order modulation, the supporting capability for uplink high-order modulation can be indicated by adding the expanded cell capability information. The information about the supporting capability for uplink high-order modulation is represented by indicating the supporting or indicating the not-supporting.

According to another aspect of the present invention, the supporting capability for uplink high-order modulation may comprise any one of the following or the combination thereof: uplink 16 QAM supporting capability, 64 QAM supporting capability, OQAM supporting capability, the supporting capability for all modulation modes of 16 QAM and the QAM with less levels, the supporting capability for all modulation modes of 64 QAM and the QAM with less levels, the supporting capability for all modulation modes of OQAM and the QAM with less levels.

Therefore, the present invention provides a method and device in which DRNC is used for reporting the capability of the cell controlled by it to support uplink high-order modulation, wherein the DRNC is used to report to the SRNC whether the cell controlled by the DRNC supports uplink high-order modulation, such that the SRNC obtain the information to determine whether uplink high-order modulation method is used on the UE.

Other features and advantages of the present invention will be set forth in the following description, and become obvious partly from the description, or can be understood through implementing the present invention. The purposes and other advantages of the present invention can be achieved and obtained through the structures specified by the specification, claims and drawings.

### BRIEF DESCRIPTION OF THE DRAWINGS

The drawings, provided for further understanding the present invention, are constitutes a part of the Specification and used for explaining the present invention along with the embodiments of the present invention, without limiting the present invention, in which:

FIG. 1 is an interaction diagram of the method for reporting the capability of a cell to support uplink high-order modulation according to a first embodiment of the present invention;

FIG. 2 is an interaction diagram of the method for reporting the capability of a cell to support the uplink high-order modulation according to the second embodiment of the present invention; and

FIG. 3 is a block diagram of the device for reporting the capability of a cell to support uplink high-order modulation according to the present invention.

### DETAILED DESCRIPTION

The present invention will be described in connection with the drawings. It is to be noted that the preferred embodiments detailed herein are only used for explaining and illustrating the present invention, not for the purpose of limiting the present invention.

The object of the present invention is to provide a method and device in which DRNC is used for reporting the capability of the cell controlled by it to support uplink high-order modulation, wherein the DRNC is used to report to the SRNC whether the cell controlled by the DRNC supports uplink high-order modulation, such that the SRNC obtains the information to determine whether the uplink high-order modulation method is used on the UE.

The method for reporting the capability of a cell to support uplink high-order modulation according to the present invention comprises one step: the DRNC reports the capability of the relative cell to support uplink high-order modulation by using signaling. In particular, after the DRNC receives the request message from SRNC, the DRNC reports via signaling to SRNC the information about the capability of the relative cell to support uplink high-order modulation

Meanwhile, the mentioned signaling is any one of the following messages:
(1) radio link setup response message, which is triggered by radio link setup request message;
(2) radio link addition response message, which is triggered by radio link addition request message;
(3) radio link setup failure message, which is triggered by radio link setup request message; and
(4) radio link addition failure message, which is triggered by radio link addition request message.

The relative cell is the neighboring cell with successfully setup or added links after the DRNC receives the request message, and the relative cell may be single or plural.

When the DRNC receives radio link setup request message or radio link addition request message and one or more desired links have been setup successfully, the information on the neighboring cell with successfully setup or added links is carried in the radio link setup response message or radio link addition response message.

Optionally, when the DRNC receives the radio link setup request message or the radio link addition request message in which plural radio links need to be setup or added wherein some of the links are successfully setup or added while some of the links are failed to be setup or added, the information on the relative cell with successfully setup and added links is carried in the radio link setup failure message or the radio link addition failure message.

Uplink high-order modulation mode refers to the modulation mode of 16 QAM, or 64 QAM, or OQAM.

In addition, the following method can be used to indicate the information about whether to support high-order modulation:
1. adding the supporting capabilities for uplink 16 QAM, and/or 64 QAM, and/or OQAM into the value of the “cell capability container” of the existing information cell, as in form of bit and with “0” indicating not-supporting and “1” indicating supporting;
2. adding the supporting capabilities for uplink 16 QAM, and/or all modulation modes of 64 QAM and the QAM with less levels, and/or all modulation modes of OQAM and the QAM with less levels into the value of the “cell capability container” of the existing information cell, as in form of bit and with “0” indicating not-supporting and “1” indicating supporting;
3. adding the support capabilities for all modulation modes of uplink 16 QAM and the QAM with less levels, and/or all modulation modes of 64 QAM and the QAM with less levels, and/or all modulation modes of OQAM and the QAM with less levels into the value of the “cell capability container” of the existing information cell, as in form of bit and with “0” indicating not-supporting and “1” indicating supporting; or
4. adding the expanded cell capability information.

Meanwhile, the cell capability information indicates high-order modulation supporting information by the following method:
(1) the supporting indication of 16 QAM, and/or the supporting indication of 64 QAM, and/or the supporting indication of OQAM;
(2) the supporting indication of 16 QAM, and/or the supporting indication of all modulation capabilities of 64 QAM and the QAM with less levels, and/or the supporting indications of all modulation capabilities of OQAM and the QAM with less levels; and
(3) the supporting indication of all modulation capabilities of 16 QAM and the QAM with less levels, and/or the supporting indication of all modulation capabilities of 64 QAM and the QAM with less levels, and/or the supporting indication of all modulation capabilities of OQAM and the QAM with less levels.

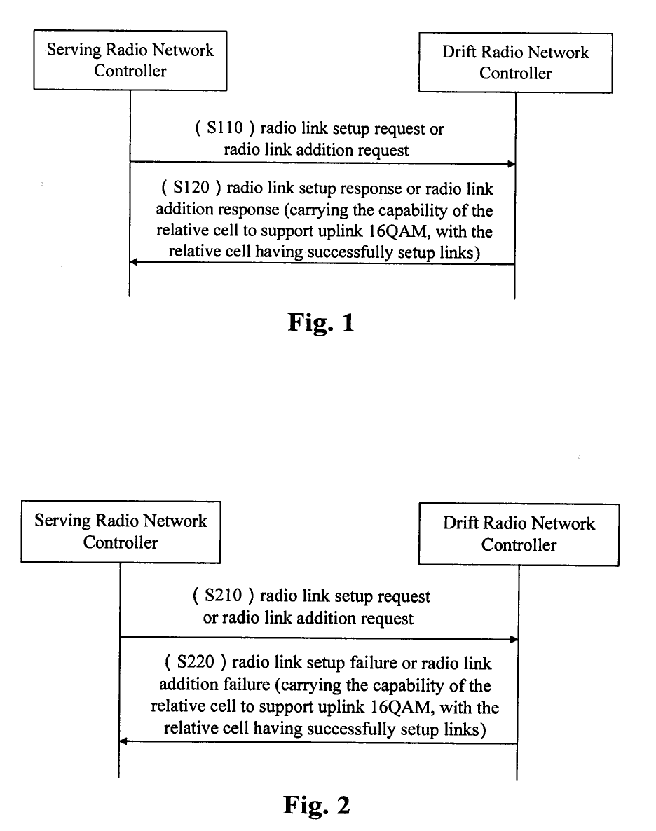

FIG. 1 is an interaction diagram of the method for reporting the capability of a cell to support uplink high-order modulation according to a first embodiment of the present invention; and FIG. 2 is an interaction diagram of the method for reporting the capability of a cell to support uplink high-order modulation according to a second embodiment of the present invention. The method for reporting the capability of a cell to support uplink high-order modulation will be described in connection with FIG. 1 and FIG. 2 in the following description.

### Embodiment 1

FIG. 1 is the interaction diagram of the method for reporting the capability of a cell to support uplink high-order modulation according to the first embodiment of the present invention. As shown in FIG. 1, there is provided a method in which DRNC reports the capability of the cell controlled by it to support uplink high-order modulation through the process of successfully setup or added links. The method can comprise the following steps:

Step S110, the SRNC sends to the DRNC a radio link setup request message or a radio link addition request message; and

Step S120, when the DRNC has successfully setup or added the links needed to be setup or added, the DRNC sends to the SRNC a radio link setup response message or a radio link addition response message in which the information about the capability of the neighboring cell to support uplink 16 QAM is carried, with the neighboring cell having successfully setup links.

### Embodiment 2

FIG. 2 is the interaction diagram of the method for reporting the capability of a cell to support uplink high-order modulation according to the second embodiment of the present invention. As shown in FIG. 2, there is provided a method in which the DRNC reports the capability of the cell controlled by the DRNC to support uplink high-order modulation through the process of unsuccessfully setup or added links. The method may comprise the following steps:

Step S210, the SRNC sends to the DRNC the radio link setup request message or the radio link addition request message; and

Step S220, when the DRNC has partly setup or added the links needed to be setup or added, the DRNC sends to the SRNC the radio link setup failure message or the radio link addition failure message in which the information about the capability of the neighboring cell to support uplink 16 QAM is carried, with the neighboring cell having successfully setup links.

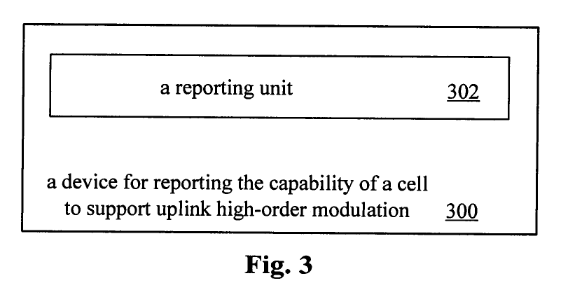

FIG. 3 is the block diagram of the device 300 for reporting the capability of a cell to support uplink high-order modulation according to the present invention. As shown in FIG. 3, the device comprises: a reporting unit 302 which reports via signaling to the SRNC the information about the capability of the relative cell to support uplink high-order modulation, after receiving the request message from the SRNC.

Meanwhile, the request message can comprise any one of the following: radio link setup request message and radio link addition request message. The signaling can comprise any one of the following: radio link setup response message, radio link setup failure message, radio link addition response message, and radio link addition failure message.

When the DRNC receives the radio link setup request message or the radio link addition request message and one or more desired links have been setup or added successfully, the information about the capability of the relative cell to support uplink high-order modulation is carried in the radio link setup response message or the radio link addition response message delivered to the SRNC by the reporting unit.

When the DRNC receives the radio link setup request message or the radio link addition request message and some of the plural links have been successfully setup or added but some of those have been failed to be setup or added, the information about the capability of the relative cell to support uplink high-order modulation is carried in the radio link setup failure message or the radio link addition failure message delivered to the SRNC by the reporting unit.

Meanwhile, the relative cell, including one or more cells, is the neighboring cell with successfully setup or added links after the DRNC has received the request message.

In addition, the reporting using signaling can be effected by adding the information about the supporting capability for uplink high-order modulation into the each of the cell capability container of the existing information cell. The supporting capability for uplink high-order modulation can be indicated in form of bit, with “0” denoting not-supporting uplink high-order modulation, and “1” denoting supporting uplink high-order modulation.

In the information about the supporting capability for uplink high-order modulation, the supporting capability for uplink high-order modulation can be indicated by adding expanded cell capability information. The information about the supporting capability for uplink high-order modulation is represented by the supporting indication or the not-supporting indication.

The supporting capability for uplink high-order modulation can comprise any one of the following or the combination thereof: uplink 16 QAM supporting capability, 64 QAM supporting capability, OQAM supporting capability, the support capabilities for all modulation modes of 16 QAM and the QAM with less levels, the supporting capabilities for all modulation modes of 64 QAM and the QAM with less levels, the support capabilities for all modulation modes of OQAM and the QAM with less levels.

Collectively, the present invention provides a method and device in which the DRNC reports the capability of the cell controlled by the DRNC to support uplink high-order modulation, wherein the DRNC reports to the SRNC whether the cell controlled by the DRNC supports uplink high-order modulation, such that the SRNC can obtain the information to determine whether to use uplink high-order modulation method on the UE.

Above description is only about the preferable embodiments of the present invention but not for limiting the present invention. It is apparent to those skilled in the art that various alterations and changes can be made to the present invention. The scope claimed by the present invention should cover any alterations, equivalent substitutions, and modifications fallen into the spirit and principle of the present invention.

What is claimed is:

1. A method for reporting the capability of a cell to support uplink high-order modulation, in which drift radio network controller is used for reporting whether the relative cell supports uplink high-order modulation, characterized in that comprising the following steps:
after receiving a request message from serving radio network controller, said drift radio network controller reports via signaling to the serving radio network controller the information about the capability of the relative cell to support the uplink high-order modulation.

2. The method according to claim 1, characterized in that said request message comprises any one of the following: radio link setup request message, and radio link addition request message.

3. The method according to claim 2, characterized in that said signaling comprises any one of the following or the combination thereof: radio link setup response message, radio link setup failure message, radio link addition response message, and radio link addition failure message.

4. The method according to claim 3, characterized in that, when said drift radio network controller receives the radio link setup request message or the radio link addition request message and one or more desired links have been setup or added successfully, the information about the capability of the relative cell to support the uplink high-order modulation is carried in the radio link setup response message or the radio link addition response message delivered to said serving radio network controller.

5. The method according to claim 3, characterized in that, when said drift radio network controller receives the radio link setup request message or the radio link addition request message and some of the plural links have been successfully setup or added but some of those have been failed to be setup or added, the information about the capability of the relative cell to support the uplink high-order modulation is carried in the radio link setup failure message or the radio link addition failure message delivered to said serving radio network controller.

6. The method according to claim 1, characterized in that, said relative cell is the neighboring cell with successfully setup or added links after said drift radio network controller receives said request message and said relative cell includes one or more cells.

7. The method according to claim 1, characterized in that, said reporting using signaling are effected by adding the information about the supporting capability for the uplink high-order modulation into the value of the cell capability container of the existing information cell.

8. The method according to claim 7, characterized in that said supporting capability for the uplink high-order modulation is indicated in the form of bit, with “0” denoting not-supporting the uplink high-order modulation, and “1” denoting supporting the uplink high-order modulation.

9. The method according to claim 1, characterized in that, in the information about the supporting capability for the uplink high-order modulation, the supporting capability for the uplink high-order modulation is indicated by adding expanded cell capability information.

10. The method according to claim 9, characterized in that the information about the support capability for the uplink high-order modulation is represented by a supporting indication or a not-supporting indication.

11. The method according to claim 1, characterized in that the supporting capability for the uplink high-order modulation comprises any one of the following or the combination thereof: uplink 16 QAM supporting capability, 64 QAM supporting capability, OQAM supporting capability, the support capabilities for all modulation modes of 16 QAM and the QAM with less levels, the support capabilities for all modulation modes of 64 QAM and the QAM with less levels, the support capabilities for all modulation modes of OQAM and the QAM with less levels.

12. A device for reporting the capability of a cell to support uplink high-order modulation, in which drift radio network controller is used for reporting whether relative cell supports uplink high-order modulation, characterized in that the device comprises:
a reporting unit, which, after receiving a request message from serving radio network controller, reports via signaling to the serving radio network controller the information about the capability of the relative cell to support the uplink high-order modulation.

13. The device according to claim 12, characterized in that, the request message comprises any one of the following: radio link setup request message, and radio link addition request message; and the signaling comprises any one of the following or the combination thereof: radio link setup response message, radio link setup failure message, radio link addition response message, and radio link addition failure message.

14. The device according to claim 13, characterized in that, when the drift radio network controller receives the radio link setup request message or the radio link addition request message and one or more desired links have been setup or added successfully, the information about the capability of the relative cell to support the uplink high-order modulation is carried in the radio link setup response message or the radio link addition response message delivered to the serving radio network controller by the reporting unit.

15. The device according to claim 13, characterized in that, when the drift radio network controller receives the radio link setup request message or the radio link addition request message and some of the plural links have been successfully setup or added but some of those have been failed to be setup or added, the information about the capability of the relative cell to support the uplink high-order modulation is carried in the radio link setup failure message or the radio link addition failure message delivered to the serving radio network controller by the reporting unit.

16. The device according to claim 12, characterized in that, the relative cell is the neighboring cell with successfully setup or added links after the drift radio network controller receives the request message and the relative cell includes one or more cells.

17. The device according to claim 12, characterized in that, the reporting using signaling is effected by adding the information about the supporting capability for the uplink high-order modulation into the value of the cell capability container of the existing information cell, and the supporting capability for the uplink high-order modulation is indicated in the form of bit, wherein “0” denotes not-supporting the uplink high-order modulation, and “1” denotes supporting the uplink high-order modulation.

18. The device according to claim 12, characterized in that, in the information about the supporting capability for the uplink high-order modulation, the supporting capability for the uplink high-order modulation is represented by adding the expanded cell capability information, and the information about the supporting capability for the uplink high-order modulation is represented by a supporting indication or a not-supporting indication.

19. The device according to claim 12, characterized in that the supporting capability for the uplink high-order modulation comprises any one of the following or the combination thereof: uplink 16 QAM supporting capability, 64 QAM supporting capability, OQAM supporting capability, the supporting capabilities for all modulation modes of 16 QAM and the QAM with less levels, the support capabilities for all modulation modes of 64 QAM and the QAM with less levels, the support capabilities to all modulation modes of OQAM and the QAM with less levels.
